(19) United States
(12) Patent Application Publication
(10) Pub. No.: US 2026/0299089 A1
(43) Pub. Date: Oct. 1, 2026

(54) METHOD AND SYSTEM FOR DETECTING RADAR SIGNAL-SOURCE NUMBER BASED ON DENSITY CLUSTERING, AND TERMINAL

(71) Applicant: SHENZHEN UNIVERSITY, Shenzhen, Guangdong (CN)

(72) Inventors: Qiang LI, Shenzhen (CN); Siqi WANG, Shenzhen (CN); Lei HUANG, Shenzhen (CN); Sijia LAI, Shenzhen (CN); Wanchun ZHANG, Shenzhen (CN); Hongcheng ZHUANG, Shenzhen (CN); Tao LIU, Shenzhen (CN); Zhaohua LU, Shenzhen (CN); Qiao YAN, Shenzhen (CN)

(73) Assignee: SHENZHEN UNIVERSITY, Shenzhen, Guangdong (CN)

(21) Appl. No.: 19/327,649

(22) Filed: Sep. 12, 2025

(30) Foreign Application Priority Data
Mar. 26, 2025 (CN) 202510363434.6

(51) Int. Cl. G01S 7/41; G01S 7/02

(52) U.S. Cl. CPC G01S 7/418; G01S 7/023; G01S 7/414

(57) ABSTRACT

A method and system for detecting radar signal-source number based on density clustering, and a terminal. The method includes generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to Gerschgorin Disk Estimator; obtaining a noise background, and when the noise background is a Gaussian colored-noise background, compressing and standardizing the radius vector to obtain a target radius matrix; clustering the target radius matrix using a target clustering algorithm to obtain a clustering result; and obtaining a target cluster based on the clustering result, and obtaining a number of radar signal sources based on the target cluster. Accuracy of estimating the number of signal sources is improved.

### CROSS-REFERENCE TO RELATED APPLICATION(S)

The present application claims priority to Chinese Patent Application No. 202510363434.6, filed on Mar. 26, 2025, and the content of all of which is incorporated by reference in the present application.

### TECHNICAL FIELD

The present disclosure relates to the technical field of array signal processing, in particular to a method and system for detecting radar signal-source number based on density clustering, and a terminal.

### BACKGROUND

In array radar signal-processing technology, signal-source angle estimation, i.e. estimation of direction of arrival (DOA) of radar echo signals, is a key issue. Many spatial angle-estimation algorithms, such as Multiple Signal Classification (MUSIC) and Estimation of Signal Parameters via Rotational Invariance Techniques (ESPRIT), rely on the accurate number of radar signal sources (the radar echo signals) as a priori input. However, in actual application, the number of signal sources is generally unknown. Therefore, it is necessary to accurately estimate the number of signal sources.

At present, performance of various methods for estimating the number of signal sources in the prior art is poor under colored-noise conditions. Although Gerschgorin Disk Estimator (GDE) can estimate the number of signal sources under spatial colored noise, accuracy of GDE is not high under low signal-to-noise ratio (SNR) conditions, which affects the estimation of the number of signal sources, thereby leading to inaccurate estimation of DOA of radar echo signals.

Therefore, the prior art still needs to be improved and developed.

### SUMMARY

A main purpose of the present disclosure is to provide a method and system for detecting radar signal-source number based on density clustering, a terminal, and a computer-readable storage medium, to solve the problem that the performance of the various methods for estimating the number of signal sources in the prior art is poor under colored-noise conditions, although GDE can estimate the number of signal sources under spatial colored noise, the accuracy of GDE is not high under low signal-to-noise ratio (SNR) conditions, which affects the estimation of the number of signal sources, thereby leading to the inaccurate estimation of DOA of radar echo signals.

In order to achieve the above purpose, the present disclosure provides a method for detecting radar signal-source number based on density clustering, and the method includes following steps:
generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to Gerschgorin Disk Estimator;
obtaining a noise background, and when the noise background is a Gaussian colored-noise background, compressing and standardizing the radius vector to obtain a target radius matrix;
clustering the target radius matrix using a target clustering algorithm to obtain a clustering result; and,
obtaining a target cluster based on the clustering result, and obtaining a number of radar signal sources based on the target cluster.

In some embodiments, the step of generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to Gerschgorin Disk Estimator, includes following steps:
constructing an array steering vector corresponding to each signal source based on the target radar antenna-array information, generating a steering vector matrix based on the array steering vector, and generating the antenna-array received-data representation based on the steering vector matrix;
obtaining the target covariance matrix and a covariance matrix of a radar echo signal both based on the antenna-array received-data representation;
performing the unitary transformation on the target covariance matrix based on the covariance matrix of the radar echo signal to obtain the target transformation matrix; and,
according to Gerschgorin Disk Estimator, obtaining a Gerschgorin-disk radius of each Gerschgorin disk from the target transformation matrix, and generating the radius vector based on the Gerschgorin-disk radius.

In some embodiments, the step of performing the unitary transformation on the target covariance matrix based on the covariance matrix of the radar echo signal to obtain the target transformation matrix, includes following steps:
dividing the target covariance matrix into blocks based on the covariance matrix of the radar echo signal to obtain a result after division, and obtaining a principal submatrix based on the result after division;
performing eigenvalue decomposition on the principal submatrix to obtain an eigenspace vector of the principal submatrix; and,
constructing a unitary-transformation matrix based on the eigenspace vector, and performing a unitary-transformation operation on the eigenspace vector based on the unitary transformation matrix to obtain the target transformation matrix.

In some embodiments, the step of obtaining a noise background, and when the noise background is a Gaussian colored-noise background, compressing and standardizing the radius vector to obtain a target radius matrix, includes following steps:
obtaining the noise background, and determining a type of the noise background;
when the noise background is the Gaussian colored-noise background, compressing each Gerschgorin-disk radius of the radius vector based on the unitary-transformation matrix and a circle center of each Gerschgorin disk to obtain a plurality of compression radii;
standardizing each compression radius to obtain a target radius of each Gerschgorin disk; and,
generating the target radius matrix based on the target radius.

In some embodiments, after the step of obtaining the noise background, and determining a type of the noise background, the method further includes following steps:
when the noise background is a Gaussian white-noise background, performing a logarithmic transformation on the radius vector to obtain a logarithmic-transformation matrix;
clustering the logarithmic-transformation matrix using the target clustering algorithm to obtain a white-noise clustering result; and,
obtaining a white-noise target cluster based on the white-noise clustering result, and obtaining the corresponding number of radar signal sources based on the white-noise target cluster.

In some embodiments, the step of clustering the target radius matrix using a target clustering algorithm to obtain a clustering result, includes following steps:
obtaining a preset distance threshold and a preset minimum neighborhood number, and using the target radius matrix, the distance threshold, and the minimum neighborhood number as an input for clustering;
during a process of the clustering, traversing each element of the target radius matrix, selecting core objects based on the minimum neighborhood number, adding the core objects to a core-object set and generating an ordered sequence, calculating a core distance and a reachable distance both of each core object, and based on the core distance and the reachable distance both of each core object of the ordered sequence, dividing all the core objects respectively into groups of a current clustering cluster, a new clustering cluster, and a noise point; and,
generating the clustering result based on the current clustering cluster, the new clustering cluster, and the noise point.

In some embodiments, the step of obtaining a target cluster based on the clustering result, and obtaining a number of radar signal sources based on the target cluster, includes following steps:
calculating average values of the current clustering cluster and the new clustering cluster both of the clustering result, and selecting a cluster with a greater average value as the target cluster; and,
counting a number of elements of the target cluster, and outputting the number of elements as the number of radar signal sources.

In addition, in order to achieve the above purpose, the present disclosure further provides a system for detecting radar signal-source number based on density clustering, and the system includes:
a radius-vector generation module, configured to generate an antenna-array received-data representation based on target radar antenna-array information, obtain a target covariance matrix based on the antenna-array received-data representation, perform a unitary transformation on the target covariance matrix to obtain a target transformation matrix, and generate a radius vector corresponding to the target transformation matrix according to Gerschgorin Disk Estimator;
a target-radius-matrix generation module, configured to obtain a noise background, and when the noise background is a Gaussian colored-noise background, compress and standardize the radius vector to obtain a target radius matrix;
a clustering-result generation module, configured to cluster the target radius matrix using a target clustering algorithm to obtain a clustering result; and,
a result-output module, configured to obtain a target cluster based on the clustering result, and obtain a number of radar signal sources based on the target cluster.

In addition, in order to achieve the above purpose, the present disclosure further provides a terminal, which includes a memory, a processor, and a program for detecting radar signal-source number based on density clustering, where the program is stored on the memory and executable on the processor, and the program, when executed by the processor, implements the steps of the method for detecting radar signal-source number based on density clustering as described above.

In addition, in order to achieve the above purpose, the present disclosure further provides a computer-readable storage medium, which stores a program for detecting radar signal-source number based on density clustering, where the program, when executed by a processor, implements the steps of the method for detecting radar signal-source number based on density clustering as described above.

The present disclosure generates an antenna-array received-data representation based on target radar antenna-array information, obtains a target covariance matrix based on the antenna-array received-data representation, performs a unitary transformation on the target covariance matrix to obtain a target transformation matrix, and generates a radius vector corresponding to the target transformation matrix according to GDE; obtains a noise background, and when the noise background is a Gaussian colored-noise background, compresses and standardizes the radius vector to obtain a target radius matrix; clusters the target radius matrix using a target clustering algorithm to obtain a clustering result; and obtains a target cluster based on the clustering result, and obtains a number of radar signal sources based on the target cluster. In the present disclosure, the Gerschgorin-disk radii obtained by performing the unitary transformation on the signal covariance matrix under the Gaussian colored-noise background are compressed and standardized, thereby reducing redundant information and improving distinguishability between noise and signals. The target clustering algorithm is then used to cluster the target radius matrix, and the corresponding radii are divided into noise clusters and signal clusters through clustering, so as to effectively distinguish noise and signals, thereby improving the accuracy of estimating the number of signal sources under low signal-to-noise conditions and colored-noise conditions.

### BRIEF DESCRIPTION OF DRAWINGS

FIG. 1 is a flow chart of a method for detecting radar signal-source number based on density clustering in an embodiment of the present disclosure.

FIG. 2 is a schematic diagram of Gerschgorin disks of an original covariance matrix in the method for detecting radar signal-source number based on density clustering in the present disclosure.

FIG. 3 is a schematic diagram of Gerschgorin disks of a target transformation matrix after a unitary transformation in the method for detecting radar signal-source number based on density clustering in the present disclosure.

FIG. 4 is a schematic diagram of performance comparison of methods for estimating the number of signal sources under a white-noise background in the method for detecting radar signal-source number based on density clustering in the present disclosure.

FIG. 5 is a schematic diagram of performance comparison of the methods for estimating the number of signal sources under a colored-noise background in the method for detecting radar signal-source number based on density clustering in the present disclosure.

FIG. 6 is a structural diagram of a system for detecting radar signal-source number based on density clustering in an embodiment of the present disclosure.

FIG. 7 is a structural diagram of a terminal in an embodiment of the present disclosure.

### DETAILED DESCRIPTION OF EMBODIMENTS

In order to make the purposes, technical solutions, and advantages of the present disclosure clearer and more specific, the present disclosure is further described in detail below with reference to the accompanying drawings and embodiments. It should be understood that the embodiments described herein are only used to explain the present disclosure and are not used to limit the present disclosure.

In array radar signal-processing technology, signal-source angle estimation, i.e. estimation of direction of arrival (DOA) of radar echo signals, is a key issue. Many spatial angle-estimation algorithms, such as Multiple Signal Classification (MUSIC) and Estimation of Signal Parameters via Rotational Invariance Techniques (ESPRIT), rely on the accurate number of radar signal sources (the radar echo signals) as a priori input. However, in actual application, the number of signal sources is generally unknown. Therefore, it is necessary to accurately estimate the number of signal sources. For the problem of estimating the number of radar signal sources, various existing methods for estimating the number of signal sources include information theory methods, such as Akaike Information Criterion (AIC), Minimum Description Length (MDL), Effective Detection Criterion (EDC), Spatial Smoothing Rank (SSR), and Gerschgorin Disk Estimator (GDE). Under a condition of spatial white noise, MDL is consistent estimation, but AIC is not consistent estimation. Therefore, under a condition of large samples, AIC has an over-estimation problem; moreover, since the two methods are derived based on a white-noise signal model, performance of the two methods is greatly degraded or even completely invalidated under a condition of colored noise. Although GDE can estimate the number of signal sources under spatial colored noise, the accuracy of GDE is poor under low SNR conditions, which affects the estimation of the number of signal sources, thereby leading to inaccurate estimation of DOA of radar echo signals.

In response to one or more of the above problems, the present disclosure generates an antenna-array received-data representation based on target radar antenna-array information, obtains a target covariance matrix based on the antenna-array received-data representation, performs a unitary transformation on the target covariance matrix to obtain a target transformation matrix, and generates a radius vector corresponding to the target transformation matrix according to GDE; obtains a noise background, and when the noise background is a Gaussian colored-noise background, compresses and standardizes the radius vector to obtain a target radius matrix; clusters the target radius matrix using a target clustering algorithm to obtain a clustering result; and obtains a target cluster based on the clustering result, and obtains a number of radar signal sources based on the target cluster.

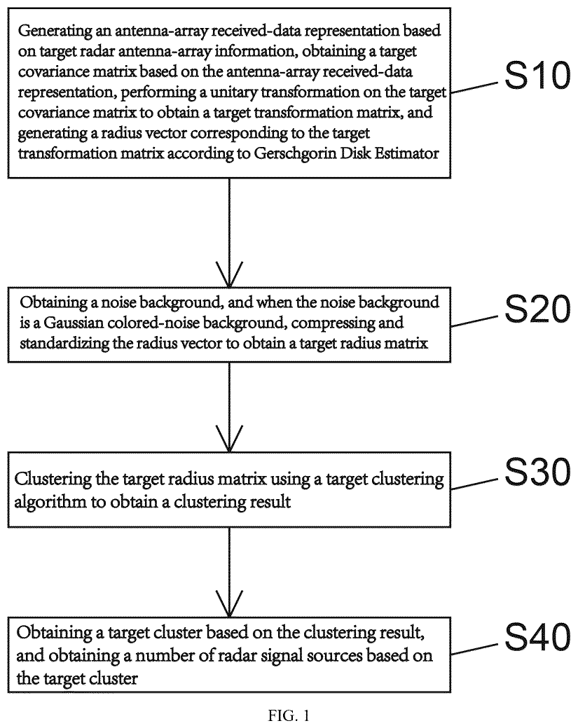

A method for detecting radar signal-source number based on density clustering in an embodiment of the present disclosure is shown in FIG. 1, the method for detecting radar signal-source number based on density clustering includes following step:

Step S10, generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to Gerschgorin Disk Estimator (GDE).

It should be noted that, under low SNR conditions and spatial colored-noise conditions, the present disclosure solves the problem of estimating the number of array radar signal sources. In the present disclosure, the target radar antenna-array information includes the number of array elements, radar echo signals, an angle, a radar echo wavelength, and a spacing between the antenna array elements. The antenna-array received-data representation is correspondingly obtained by the target radar antenna-array information, so as to obtain the number of radar signal sources by applying corresponding processing processes in the present disclosure.

Further, the steps of generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to GDE, include following steps:
constructing an array steering vector corresponding to each signal source based on the target radar antenna-array information, generating a steering vector matrix based on the array steering vector, and generating the antenna-array received-data representation based on the steering vector matrix;
obtaining the target covariance matrix and a covariance matrix of a radar echo signal both based on the antenna-array received-data representation;
performing the unitary transformation on the target covariance matrix based on the covariance matrix of the radar echo signal to obtain the target transformation matrix; and,
according to GDE, obtaining a Gerschgorin-disk radius of each Gerschgorin disk from the target transformation matrix, and generating the radius vector based on the Gerschgorin-disk radius.

A radar antenna array is composed of M array elements arranged in a straight line, and K radar echo signals in a far field are incident on the array from angle θₖ (k=1, 2, . . . , K). The radar echo wavelength is λ, and the spacing of the antenna array elements is d. Then, array steering vector (array flow pattern) a(θₖ) corresponding to k-th one of the signal sources of the uniform linear array can be expressed as formula (1):

$$a ( {θ}_{k} ) = {[ 1 , exp ( - j 2 π \frac{d}{λ} sin {θ}_{k} ) , … , exp ( - j 2 π ( M - 1 ) \frac{d}{λ} sin {θ}_{k} ) ]}^{T} ; \qquad ( 1 )$$

where, exp represents exponential operation, j represents complex-number unit, j=\sqrt{−1}, and [ ]^{T} represents transposition operation.

Based on all array steering vectors, the steering vector matrix can be generated. Steering vector matrix A corresponding to antenna-array received signals is expressed as formula (2):

$$A = [ a ( {θ}_{1} ) , a ( {θ}_{2} ) , … , a ( {θ}_{K} ) ] = [ \begin{matrix}1 & 1 & … & 1 \\ {e}^{- j \frac{2 π}{λ} dsin {θ}_{1}} & {e}^{- j \frac{2 π}{λ} dsin {θ}_{2}} & … & {e}^{- j \frac{2 π}{λ} dsin {θ}_{K}} \\ ⋮ & ⋮ & ⋱ & ⋮ \\ {e}^{- j \frac{2 π}{λ} ( M - 1 ) dsin {θ}_{1}} & {e}^{- j \frac{2 π}{λ} ( M - 1 ) dsin {θ}_{2}} & … & {e}^{- j \frac{2 π}{λ} ( M - 1 ) dsin {θ}_{K}}\end{matrix} ] . \qquad ( 2 )$$

Therefore, at time t, antenna-array received data x(t) (including the radar echo signals and noises) can be expressed by the antenna-array received-data representation, and expressed as formula (3):

$$x ( t ) = A s ( t ) + n ( t ) ; \qquad ( 3 )$$

where, s(t) represents radar echo signals incident on the array at time t and is a K×1-dimensional column vector, n(t) represents colored noise with cross correlation or Gaussian white noise and is a M×1-dimensional column vector, and s(t) and n(t) are expressed as formula (4) and formula (5) respectively:

$$s ( t ) = {[ {s}_{1} ( t ) , {s}_{2} ( t ) , … , {s}_{K} ( t ) ]}^{T} ; \qquad ( 4 )$$

$$n ( t ) = {[ {n}_{1} ( t ) , {n}_{2} ( t ) , … , {n}_{M} ( t ) ]}^{T} ; \qquad ( 5 )$$

where, s₁(t) represents first one of the radar echo signals incident on the array at time t, s₂(t) represents second one of the radar echo signals incident on the array at time t, s_{K}(t) represents K-th one of the radar echo signals incident on the array at time t, n₁(t) represents the colored noise with cross correlation or the Gaussian white noise corresponding to first one of the array elements at time t, n₂(t) represents the colored noise with cross correlation or the Gaussian white noise corresponding to second one of the array elements at time t, and n_{M}(t) represents the colored noise with cross correlation or the Gaussian white noise corresponding to M-th one of the array elements at time t.

Covariance matrix R (i.e. the target covariance matrix) of x(t) in antenna-array received-data representation and covariance matrix Rₛ (i.e. the covariance matrix of the radar echo signals) of s(t) in the antenna-array received-data representation, are expressed as formula (6) and formula (7) respectively:

$$R = \frac{1}{L} {\sum }_{t = 1}^{L} x ( t ) {x}^{H} ( t ) ; \qquad ( 6 )$$

$${R}_{s} = \frac{1}{L} {\sum }_{t = 1}^{L} s ( t ) {s}^{H} ( t ) ; \qquad ( 7 )$$

where, (·)^{H} represents conjugate transpose, and L represents the number of time-domain samples, i.e. the number of snapshots.

Further, the step of performing the unitary transformation on the target covariance matrix based on the covariance matrix of the radar echo signals to obtain the target transformation matrix, includes following steps:
dividing the target covariance matrix into blocks based on the covariance matrix of the radar echo signals to obtain a result after division, and obtaining a principal submatrix based on the result after division;
performing eigenvalue decomposition on the principal submatrix to obtain an eigenspace vector of the principal submatrix; and,
constructing a unitary-transformation matrix based on the eigenspace vector, and performing a unitary-transformation operation on the eigenspace vector based on the unitary-transformation matrix to obtain the target transformation matrix.

It should be noted that the present disclosure uses GDE, and does not need to know an exact eigenvalue. Instead, the present disclosure estimates the number of signal sources by estimating a distribution range of the eigenvalues based on GDE. R can be set to be an M×M-denmention matrix, in which an element in i-th row and χ-th column is r_{iχ}. Absolute values of elements in the i-th row except the element (removed) in both the i-th row and i-th column are summed to obtain Gerschgorin-disk radius rᵢ, which is expressed as formula (8):

$${r}_{i} = {\sum }_{χ = 1 , χ \neq i}^{M} \vert {r}_{i χ} \vert , i = 1 , 2 , … , M . \qquad ( 8 )$$

Then a corresponding point on i-th disk Oᵢ is expressed on a complex plane as formula (9):

$$\vert Z - {r}_{ii} \vert < {r}_{i} ; \qquad ( 9 )$$

where, rᵢᵢ represents a center of the i-th disk, which is Gerschgorin disk, and Z represents a complex number satisfying formula (8) on the complex plane.

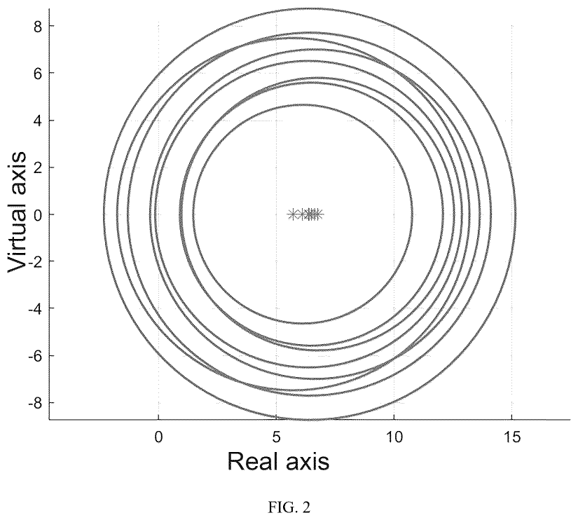

When drawing Gerschgorin disks of covariance matrix R according to GDE, as shown in FIG. 2, it can be found that both the Gerschgorin-disk radii of the radar echo signals and the Gerschgorin-disk radii of the noises are significantly larger, and center positions of all Gerschgorin disks almost coincide. This indicates that using current covariance matrix R to estimate the number of signal sources lacks distinguishability and cannot obtain accurate results. In response to this situation, the present disclosure requires separating signal disks and noise disks.

In order to separate the signal disks and the noise disks, the present disclosure needs to perform the unitary transformation on covariance matrix R. Firstly, a result after block division is obtained by perform the block division on R, which is expressed as formula (10):

$$R = [ \begin{matrix}{R}^{′} & ζ \\ {ζ}^{H} & {c}_{MM}\end{matrix} ] ; \qquad ( 10 )$$

where, R′ is an M−1-dimension principal submatrix, ζ is first M−1 elements in M-th column of R, and c_{MM} is an element in the last row and the last column both of matrix R.

Eigenvalue decomposition is performed on principal submatrix R′, which is expressed as formula (11):

$${R}^{′} = U \sum {U}^{H} ; \qquad ( 11 )$$

where, Σ is a diagonal matrix composed of eigenvalues λ₁, λ₂, λ₃, . . . , λ_{M-1} of R′, i.e. Σ=diag(λ₁, λ₂, . . . , λ_{M-1}), diag(·) represents generating a diagonal matrix by taking an element of a vector as a diagonal element; λ₁ represents first one of the eigenvalues of R′, λ₂ represents second one of the eigenvalues of R′, λ₃ represents third one of the eigenvalues of R′, and λ_{M-1} represents M−1-th one of the eigenvalues of R′; U is eigenvector space of R′, i.e. U=[u₁, u₂, . . . , u_{M-1}], u₁ represents first one eigenvector in the eigenvector space U of R′, u₂ represents second one eigenvector in the eigenvector space U of R′, and u_{M-1} represents M−1-th one eigenvector in the eigenvector space U of R′; based on characteristics of eigenvectors, UU^{H}=I is obtained, herein I represents an M−1-dimension identity matrix.

Further, unitary-transformation matrix W is constructed based on eigenvector space U of R′, which is expressed as formula (12):

$$W = [ \begin{matrix}U & 0 \\ {0}^{T} & 1\end{matrix} ] . \qquad ( 12 )$$

The unitary transformation is performed on covariance matrix R to obtain the unitary-transformation matrix, i.e. target transformation matrix R_{W}, which is expressed as formula (13):

$${R}_{W} = {W}^{H} RW = [ \begin{matrix}\sum & {U}^{H} ζ \\ {ζ}^{H} U & {c}_{MM}\end{matrix} ] = [ \begin{matrix}{λ}_{1} & 0 & … & 0 & {ρ}_{1} \\ 0 & {λ}_{2} & … & 0 & {ρ}_{2} \\ ⋮ & ⋮ & & ⋮ & ⋮ \\ 0 & 0 & … & {λ}_{M - 1} & {ρ}_{M - 1} \\ {ρ}_{1}^{*} & {ρ}_{2}^{*} & … & {ρ}_{M - 1}^{*} & {c}_{MM}\end{matrix} ] ; \qquad ( 13 )$$

where,

$$ζ = {A}_{1} {R}_{s} {b}_{M}^{⋆} ;$$

A₁ a matrix formed by taking first M−1 rows and first M−1 columns both of steering vector matrix A; (·) * represents complex conjugation; b_{M} is a first parameter, which is expressed as formula (14):

$${b}_{M} = [ \begin{matrix}{e}^{j ( γ - 1 ) {β}_{1}} \\ \begin{matrix}{e}^{j ( γ - 1 ) {β}_{2}} \\ \begin{matrix}⋮ \\ {e}^{j ( γ - 1 ) {β}_{K}}\end{matrix}\end{matrix}\end{matrix} ] ; \qquad ( 14 )$$

where,

$$γ = 1 , 2 , … , M - 1 ; {β}_{k} = \frac{2 π d sin {θ}_{k}}{λ} ; k = 1 , 2 , … , K .$$

Further, in formula (13), ρ_{γ} is a radius element, which is expressed as formula (15):

$${ρ}_{γ} = {u}_{γ}^{H} ζ , γ = 1 , 2 , … , M - 1 ; \qquad ( 15 )$$

where, u_{γ} is y-th one eigenvector of R′.

According to GDE, in formula (13), i.e. in the target transformation matrix, Gerschgorin-disk radius r̅_̅{̅γ̅}̅ of R_{W} can be expressed as formula (16):

$$\overline{{r}_{γ}} = \vert {ρ}_{γ} \vert , γ = 1 , 2 , … , M - 1 ; \qquad ( 16 )$$

where, |·| represents performing an absolute-value operation on elements or elements in vectors or matrices.

Based on M−1 Gerschgorin-disk radii of R_{W}, corresponding radius vector r̅ can be formed, which is expressed as the following formula (17):

$$\overline{r} = [ \overline{{r}_{1}} , \overline{{r}_{2}} , … , \overline{{r}_{M - 1}} ] . \qquad ( 17 )$$

For each Gerschgorin-disk radius, formula (18) can be obtained according to Inequality theorem:

$$\overline{{r}_{γ}} = \vert {ρ}_{γ} \vert = \vert {u}_{γ}^{H} {A}_{1} {R}_{s} {b}_{M}^{⋆} \vert \leq \vert {u}_{γ}^{H} {A}_{1} \vert \vert {R}_{s} {b}_{M}^{⋆} \vert = μ \vert {u}_{γ}^{H} {A}_{1} \vert , γ = 1 , 2 , … , M - 1 ; \qquad ( 18 )$$

where,

$$μ = \vert {R}_{S} {b}_{M}^{⋆} \vert$$

is a row vector.

According to formula (18), μ is independent of γ, indicating that the Gerschgorin-disk radii depend only on

$$\vert {u}_{γ}^{H} {A}_{1} \vert .$$

When eigenvector μ_{γ} takes the eigenvector of noise, it is orthogonal to the array flow pattern, therefore elements in

$$\vert {u}_{γ}^{H} {A}_{1} \vert$$

are close to zero. When eigenvector u_{γ} takes the eigenvector of radar echo signal, the elements in

$$\vert {u}_{γ}^{H} {A}_{1} \vert$$

are significantly greater than zero.

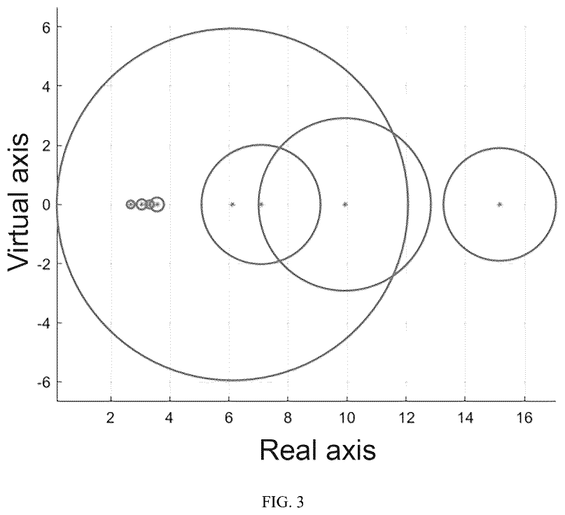

According to GDE, Gerschgorin disks of R_{W} are drawn as shown in FIG. 3. It can be seen from FIG. 3 that the disk radius corresponding to the radar echo signal in generated Gerschgorin disks of R_{W} after unitary transformation is significantly larger than the disk radius corresponding to the noise, and separation between centers of disks is higher. This result indicates that generated Gerschgorin disks of matrix R_{W} after unitary transformation has distribution characteristics such as high contrast, low overlap, and strong separability.

Step S20, obtaining a noise background, and when the noise background is a Gaussian colored-noise background, compressing and standardizing the radius vector to obtain a target radius matrix.

Characteristics of Gerschgorin disks generated from the target transformation matrix meets the requirements of Ordering Points To Identify the Clustering Structure (OPTICS) algorithm for density separability and cluster spacing. Using the data as an input of OPTICS algorithm can significantly improve the reliability and accuracy of estimating the number of radar signal sources. Therefore, the present disclosure performs OPTICS clustering on the extracted radii of R_{W}, where OPTICS algorithm is a target clustering algorithm. Before clustering, in order to eliminate the influence of data scale and provide more standardized data input for OPTICS clustering algorithm, the present disclosure is based on the noise background for response processing.

Further, the step of obtaining a noise background, and when the noise background is a Gaussian colored-noise background, compressing and standardizing the radius vector to obtain a target radius matrix, includes following steps:
obtaining the noise background, and determining a type of the noise background;
when the noise background is the Gaussian colored-noise background, compressing each Gerschgorin-disk radius of the radius vector based on the unitary-transformation matrix and a circle center of each Gerschgorin disk to obtain a plurality of compression radii;
standardizing each compression radius to obtain a target radius of each Gerschgorin disk; and,
generating the target radius matrix based on the target radius.

When the noise background is the Gaussian colored-noise background, based on the unitary-transformation matrix and the circle center of each Gerschgorin disk, each Gerschgorin-disk radius in the radius vector is compressed to obtain the plurality of compression radii

$${r}_{γ}^{′} ,$$

which are compressed using formula (19):

$${r}_{γ}^{′} = \frac{\overline{{r}_{γ}}}{( {λ}_{γ} \times {c}_{MM} )} ; \qquad ( 19 )$$

where, γ=1, 2, . . . , M−1; λ_{γ} is a center circle of Gerschgorin disk; c_{MM} is an element in the last row and last column of matrix R_{W} after unitary transformation; by compressing a ratio of

$${\overline{r}}_{γ}^{2}$$

to λ_{γ}×c_{MM}, a numerical range of radius can be effectively reduced, thereby reducing a dynamic range of data.

Afterwards, each compression radius is standardized to obtain target radius

$${r}_{γ}^{′′}$$

of each Gerschgorin disk, which is standardized using formula (20):

$${r}_{γ}^{′′} = \sqrt{\frac{{r}_{γ}^{′}}{max ( {r}_{γ}^{′} )}} ; \qquad ( 20 )$$

where, max(·) represents returning a maximum value of elements in one set, and

$$max ( {r}_{γ}^{′} )$$

represents selecting a maximum value from all compression radii; the compression radii are standardized and then radius values are normalized to the range of [0,1], which helps to eliminate the influence of data scale.

Afterwards, the obtained target radii are summarized to obtain the target radius matrix, which is expressed using formula (21):

$${r}^{′′} = [ {r}_{1}^{′′} , {r}_{2}^{′′} , … , {r}_{M - 1}^{′′} ] ; \qquad ( 21 )$$

where, r″ is the target radius matrix.

Further, after the step of obtaining the noise background, and determining a type of the noise background, the method further includes following steps:
when the noise background is a Gaussian white-noise background, performing a logarithmic transformation on the radius vector to obtain a logarithmic-transformation matrix;
clustering the logarithmic-transformation matrix using the target clustering algorithm to obtain a white-noise clustering result; and,
obtaining a white-noise target cluster based on the white-noise clustering result, and obtaining the corresponding number of radar signal sources based on the white-noise target cluster.

When the noise background is the Gaussian white-noise background, the logarithmic transformation is performed on the radius vector to obtain logarithmic-transformation matrix \tilde{r}, and the logarithmic transformation is performed using formula (22):

$$\tilde{r} = {log}_{10} ( 1 + \tilde{r} ) . \qquad ( 22 )$$

Afterwards, the obtained logarithmic-transformation matrix is clustered using the target clustering algorithm to obtain the white-noise clustering result, thereby obtaining the number of radar signal sources at this moment. The process of clustering and the process of obtaining the number of radar signal sources based on corresponding clusters are the same as the process of processing the target radius matrix.

Step S30, clustering the target radius matrix using a target clustering algorithm to obtain a clustering result.

After eliminating the influence of data scale, the target radius matrix is clustered using the target clustering algorithm to distinguish between signal components and noise components.

Further, the step of clustering the target radius matrix using a target clustering algorithm to obtain a clustering result, includes following steps:
obtaining a preset distance threshold and a preset minimum neighborhood number, and using the target radius matrix, the distance threshold, and the minimum neighborhood number all as an input for clustering;
during a process of the clustering, traversing each element of the target radius matrix, selecting core objects based on the minimum neighborhood number, adding the core objects to a core-object set and generating an ordered sequence, calculating a core distance and a reachable distance both of each core object, and based on the core distance and the reachable distance both of each core object of the ordered sequence, dividing all the core objects respectively into one of groups of a current clustering cluster, a new clustering cluster, and a noise point; and,
generating the clustering result based on the current clustering cluster, the new clustering cluster, and the noise point.

In the present disclosure, the target clustering algorithm is OPTICS clustering algorithm. For OPTICS clustering algorithm, given dataset D, sample point pϵD, distance threshold ε, and minimum neighborhood number MinPts, OPTICS-correlated definitions are as follows:

ε-neighborhood: the ε-neighborhood of sample point p_{δ}ϵD is defined as a set of sample points that has a distance within ε range from p_{δ}, i.e. N_{ε}(q_{δ})={q_{δ}ϵD|d (q_{ψ}, q_{δ})≤ε}; the number of the sets of sample points is |N_{ε}(q_{δ})|, and d(q_{ψ}, q_{δ}), represents a distance from sample point q_{ψ} to sample point q_{δ}.
core object: for p_{δ}ϵD, a condition for p_{δ} being the core object is that set N_{ε}(q_{δ}) of sample points corresponding to the ε-neighborhood of p_{δ} includes no less than MinPts sample points;
density directly reached: if p_{δ} is the core object and sample point p_{ψ} is within the ε-neighborhood of p_{δ}, it is called that p_{ψ} is density directly reached through p_{δ};
density reachable: for p_{ψ} and p_{δ}, there is sample sequence q₁, q₂, . . . , q_{N}; if q₁=p_{ψ} and q_{N}=p_{δ}, and qₙ₊₁ is density directly reached through qₙ in the sample sequence, it is called that p_{δ} and is density reachable through p_{ψ}, and,
density connected: for the two points p_{ψ} and p_{δ}, if there is one core object pₖ, and p_{ψ} and p_{δ} are both density reachable through pₖ, then p_{ψ} and p_{δ} are density connected.

In the neighborhood of current core point p, a minimum neighborhood radius that enables p to become a core point is called core distance cd(p) of p, which is defined by formula (23):

$$cd ( p ) = \{ \begin{matrix}undefined & \vert {N}_{ε} ( p ) \vert < MinPts \\ d ( p , {N}_{ε}^{MinPts} ( p ) ) & \vert {N}_{ε} ( p ) \vert \geq MinPts\end{matrix} ; \qquad ( 23 )$$

where,

$${N}_{ε}^{MinPts} ( p )$$

represents a node in set N_{ε}(p) that is MinPts-th closest to node p. For sample point p, if the number of sample points |N_{ε}(p)| in its ε-neighborhood is less than MinPts, it is called that p fails to meet conditions of being the core point, and core distance cd(p) cannot be defined, which is denoted as undefined.

$$d ( p , {N}_{ε}^{MinPts} ( p ) )$$

represents a distance from

$${N}_{ε}^{MinPts} ( p )$$

to p.

For p_{ψ}, p_{δ}ϵD, reachable distance rd(p_{ψ}, p_{δ}) of p_{ψ} for p_{δ} is defined as formula (24):

$$rd ( {p}_{ψ} , {p}_{δ} ) = \{ \begin{matrix}undefined & \vert {N}_{ε} ( p ) \vert < MinPts \\ max \{ cd ( {p}_{δ} ) , d ( {p}_{ψ} , {p}_{δ} ) \} & \vert {N}_{ε} ( p ) \vert \geq MinPts\end{matrix} . \qquad ( 24 )$$

For two sample points p_{ψ} and p_{δ}, if the number of sample points |N_{ϵ}(p)| in the ε-neighborhood of p_{δ} is less than MinPts, p_{δ} is not the core point. At this time, reachable distance rd(p_{ψ}>p_{δ}) of p_{ψ} for p_{δ} can not be defined, which is denoted as undefined. cd(p_{δ}) represents a core distance of p_{δ}, and d(p_{ψ}, p_{δ}) represents a distance from p_{ψ} to p_{δ}.

In the present disclosure, the radii in the target radius matrix are classified using OPTICS clustering algorithm. Taking target radius matrix r″ obtained under the colored-noise background as an example, an objective of OPTICS algorithm is to output one ordered sequence and two attributes of target radius

$${r}_{γ}^{′′}$$

for each Gerschgorin disk, i.e. a core-distance set and a reachable-distance set.

Steps of the process of clustering are as follows.

Step 1, inputting: in the present disclosure, r″ and neighborhood parameters both as a given sample set are input into the algorithm, where the neighborhood parameters include distance threshold ε and minimum neighborhood number MinPts. ε is infinite, thus each sample point is the core object; MinPts is 2, then the core distance of each core object is a distance from a sample point closest to the each core object to the each core object itself, and the sample points are also one of neighborhood elements.

Step 2, initializing: all elements in r″ are traversed, core-object set Ω=Ø is initialized to be empty, and each element in the sample set is started to be traversed.

Step 3, processing: firstly all elements in the sample set are traversed, the core distance of each element is calculated, and if the core distance of one element exists, the one element is the core object and is placed into core-object set Ω, while if the core distance of the one element does not exist, the one element is not the core object.

After all the elements in the sample set are processed, one unprocessed core object is randomly selected from core-object set Ω and then pressed into an ordered sequence. At the same time, a neighborhood of the one core object is checked, reachable distances from unvisited points in the neighborhood to the one core object are calculated, and these points are put into seed set δ sequentially according to values of the reachable distances.

If the seed set is empty, one next unprocessed core object is randomly selected from core-object set Ω for processing. If the seed set is not empty, a point with an unvisited status and a minimum reachable distance is obtained from the seed set, and the status of the point is marked as visited and the point is pressed into ordered sequence α. If a neighborhood point obtained at this time is the core object, an unvisited neighborhood point of the neighborhood point is added to δ, and reachable distances from remaining points in seed set δ to the neighborhood point are recalculated and the remaining points are rearranged from small to large according to the reachable distances. Whether the seed set is empty continues to be determined and the above steps are repeated until all points in the seed set are visited, then one next unprocessed core object is randomly selected from core-object set Ω for processing. When all elements in core-object set Ω are processed, steps are completed, and ordered sequence α, the core-distance set, and the reachable-distance set all corresponding to r″ are output.

Step 4, outputting: after Step 3 is completed, ordered sequence α, the core-distance set, and the reachable-distance set are obtained, then reachable-distance threshold ξ is input, and sample points are extracted sequentially in the ordered sequence obtained after algorithm execution. If reachable distance of a point v_{γ}≤ξ, the point belongs to the current clustering cluster; if the reachable distance of the point is greater than ξ, and core distance of the point g_{γ}≤ξ, the point belongs to the new clustering cluster; if the reachable distance of the point is greater than ξ, and core distance of the point g_{γ}>ξ, the point belongs to the noise point.

Through the clustering, the current clustering cluster, the new clustering cluster, and the noise point can be obtained, which are the corresponding clustering result.

Step S40: obtaining a target cluster based on the clustering result, and obtaining a number of radar signal sources based on the target cluster.

After obtaining the corresponding clustering result, the corresponding number of radar signal sources is obtained through the clustering result.

Further, the step of obtaining a target cluster based on the clustering result, and obtaining a number of radar signal sources based on the target cluster, includes following steps:
calculating an average value of the current clustering cluster and the new clustering cluster both of the clustering result, and selecting a cluster with a greater average value as the target cluster; and,
counting a number of elements of the target cluster, and outputting the number of elements as the number of radar signal sources.

The average value of each cluster in the current clustering cluster and the average value of each cluster in the new clustering cluster are calculated. Average radius values are compared. A cluster with the greatest average value is a cluster corresponding to signal sources, the number of points in the cluster is counted as the number of signal sources. Finally the number of signal sources is output.

Further, a simulation experiment was conducted to compare estimation performance of the present technical method of the present disclosure with AIC, MDL, and GDE.

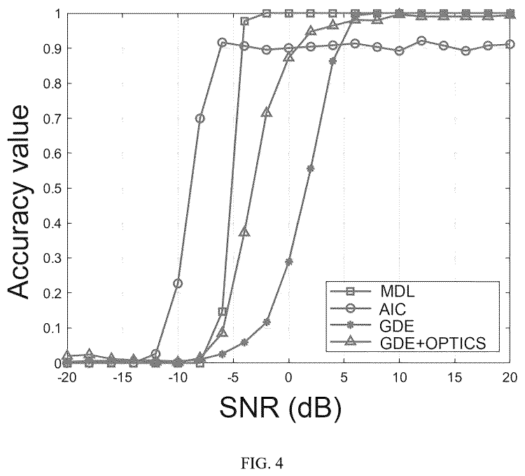

As shown in FIG. 4, a radar antenna-array model with the number of array elements M=8 and an antenna spacing of λ/2 was designed. The radar echo signals were incident on the array at the angles of 0 degrees, 10 degrees, and 30 degrees. The noise background was the Gaussian white noise. The SNR was ranged from −20 dB to 20 dB, with a step size of 2 dB. Signal power was calculated and noise power was adjusted based on changing SNR values to ensure that the noise power matches the SNR of signal. The number of snapshots was set to 500, and the reachability-distance threshold of OPTIC was set to 0.26 (selected heuristically based on empirical experience). For each SNR value, Monte Carlo experiments were repeated 1000 times, and the estimated number of signal sources in each experiment was recorded. If the estimated number of signal sources was consistent with the actual number of signal sources, it was considered one successful estimation. Final accuracy acc was calculated by dividing the number of successful times by the number of total experiment times, as expressed in formula (25):

$$acc = \frac{o u t}{t i m e s} ; \qquad ( 25 )$$

where, out represents the number of successful-estimation times, times represents the number of total experiment times. Finally an accuracy-value curve was calculated and drawn, where the x-axis represents SNR values, and the y-axis represents accuracy values. In FIG. 4, under the white-noise signal background, when the SNR range is greater than −5 dB, the accuracy values of signal-source estimation of MDL always remain at 1 and exhibit high stability. The present technical method of the present disclosure in the SNR range of −5 dB to 5 dB has significantly better accuracy values in estimating the number of signal sources than that of GDE. When the SNR range is greater than 5 dB, not only the accuracy values of the present technical method of the present disclosure are higher than that of AIC, but also the stability of the present technical method of the present disclosure is significantly better than that of AIC.

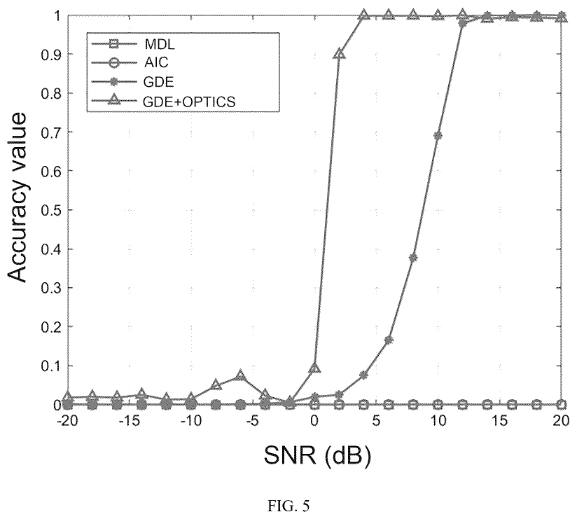

As shown in FIG. 5, a radar antenna-array model with the number of array elements M=8 and an antenna spacing of λ/2 was designed. The radar echo signals were incident on the array at the angles of 0 degrees, 10 degrees, and 30 degrees. The noise background was the colored noise. The SNR was ranged from −20 dB to 20 dB, with a step size of 2 dB. Monte Carlo experiments were repeated 1000 times. The number of snapshots was set to 500, and the reachability-distance threshold of OPTIC was set to 0.26 (selected heuristically based on empirical experience). In the experiment, in order to simulate an actual noise environment, the white noise was filtered by one designed 4-order Butterworth low-pass filter with a cutoff frequency of 0.6, and the generated filtered noise became the colored noise. In the experiment, the performance under different SNRs was compared using the same means as in Experiment 1, and an accuracy-value curve was calculated and drawn. As shown in FIG. 5, under the colored-noise background, the performance of MDL and AIC significantly degrades, and the accuracy values of MDL and AIC approach 0, indicating that the two methods are almost completely ineffective under colored-noise conditions. In contrast, GDE performs better than MDL and AIC when facing the colored noise. In the SNR range of OdB to 12 dB, the present technical method of the present disclosure has significantly higher accuracy values in estimating the number of signal sources than GDE. Moreover, when the SNR range is greater than 5 dB, the accuracy values of the present technical method of the present disclosure approach 1 and maintain extremely high stability.

The present disclosure generates an antenna-array received-data representation based on target radar antenna-array information, obtains a target covariance matrix based on the antenna-array received-data representation, performs a unitary transformation on the target covariance matrix to obtain a target transformation matrix, and generates a radius vector corresponding to the target transformation matrix according to GDE; obtains a noise background, and when the noise background is a Gaussian colored-noise background, compresses and standardizes the radius vector to obtain a target radius matrix; clusters the target radius matrix using a target clustering algorithm to obtain a clustering result; and obtains a target cluster based on the clustering result, and obtains a number of radar signal sources based on the target cluster. In the present disclosure, the Gerschgorin-disk radii obtained by performing the unitary transformation on the signal covariance matrix under the Gaussian colored-noise background are compressed and standardized, thereby reducing redundant information and improving distinguishability between noise and signals. The target clustering algorithm is then used to cluster the target radius matrix, and the corresponding radii are divided into noise clusters and signal clusters through clustering, so as to effectively distinguish noise and signals, thereby improving the accuracy of estimating the number of signal sources under low signal-to-noise conditions and colored-noise conditions.

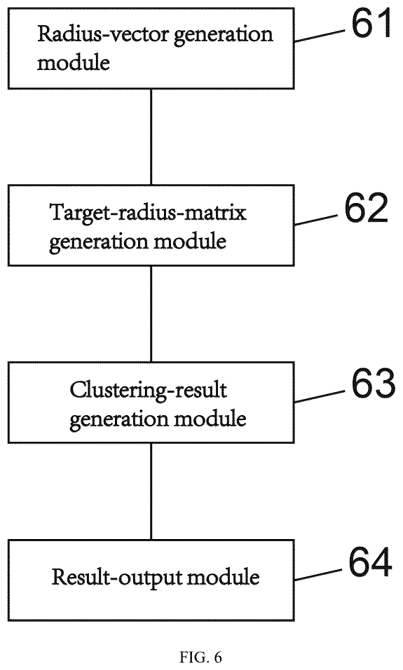

Further, as shown in FIG. 6, based on the method for detecting radar signal-source number based on density clustering mentioned above, the present disclosure further provides a system for detecting radar signal-source number based on density clustering, where the system for detecting radar signal-source number based on density clustering includes:
a radius-vector generation module 61, configured to: generate an antenna-array received-data representation based on target radar antenna-array information, obtain a target covariance matrix based on the antenna-array received-data representation, perform a unitary transformation on the target covariance matrix to obtain a target transformation matrix, and generate a radius vector corresponding to the target transformation matrix according to GDE;
a target-radius-matrix generation module 62, configured to: obtain a noise background, and when the noise background is a Gaussian colored-noise background, compress and standardize the radius vector to obtain a target radius matrix;
a clustering-result generation module 63, configured to: cluster the target radius matrix using a target clustering algorithm to obtain a clustering result; and,
a result-output module 64, configured to: obtain a target cluster based on the clustering result, and obtain a number of radar signal sources based on the target cluster.

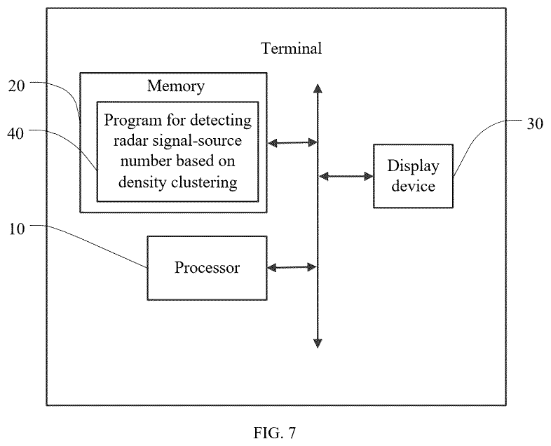

Further, as shown in FIG. 7, based on the method and system for detecting radar signal-source number based on density clustering mentioned above, the present disclosure further provides a terminal, which includes a processor 10, a memory 20, and a display device 30. FIG. 7 only shows some components of the terminal, but it should be understood that implementing all the shown components is not required, and more or fewer components can be implemented instead.

In some embodiments, the memory 20 may be an internal storage unit of the terminal, such as a hard disk or random-access memory (RAM) of the terminal. In other embodiments, the memory 20 may be an external storage device of the terminal, such as a plug-in hard disk, smart media card (SMC), secure digital (SD) card, and flash card arranged on the terminal. Further, the memory 20 may include the internal storage unit and external storage device of the terminal. The memory 20 is configured to store application software and various data both installed on the terminal, such as a program code installed on the terminal. The memory 20 may be configured to temporarily store data that has been or will be output. In one embodiment, the memory 20 stores a program 40 for detecting radar signal-source number based on density clustering, which can be executed by the processor 10 to implement the method for detecting radar signal-source number based on density clustering of the present disclosure.

In some embodiments, the processor 10 may be a central processing unit (CPU), a microprocessor, or other data-processing chips, and is configured to execute the program code or process data stored in the memory 20, such as executing the method for detecting radar signal-source number based on density clustering.

In some embodiments, the display device 30 may be an LED display device, a liquid-crystal display device, a touch-control liquid-crystal display device, and an organic light-emitting diode (OLED) touch display device. The display device 30 is configured to display information of the terminal and to display a visual user interface.

In one embodiment, when the processor 10 executes the program 40 for detecting radar signal-source number based on density clustering stored in the memory 20, the steps of the method for detecting radar signal-source number based on density clustering are implemented.

The present disclosure further provides a computer-readable storage medium (may be but is not limited to a non-volatile computer-readable storage medium) storing a program for detecting radar signal-source number based on density clustering. The program for detecting radar signal-source number based on density clustering, when executed by a processor, implements the steps of the method for detecting radar signal-source number based on density clustering as described above.

It should be noted that in the present disclosure, the terms “including”, “comprising”, or any other variation thereof are intended to include non-exclusive inclusion, such that a process, method, item, or terminal that includes a series of elements not only includes these elements, but also includes other elements not explicitly listed, or further includes elements inherent to the process, method, item, or terminal. Without further limitations, an element limited by the statement “including/comprising a/the . . . ” does not exclude the existence of other identical elements in the process, method, item, or terminal that includes the element.

Those skilled in the art can understand that implementing all or part of the steps in the above method embodiments can be accomplished by instructing relevant hardware (such as a processor and a controller) through a computer program. The program can be stored in a computer-readable storage medium that can be read by a computer, and the program can include the steps of the above method embodiments when executed. The computer-readable storage medium mentioned therein may be a memory, a magnetic disk, an optical disk, etc.

It should be understood that the application of the present disclosure is not limited to the above embodiments. For those ordinary skilled in the art, improvements or transformations can be made based on the above description, and all such improvements and transformations should fall within the protection scope of the claims attached to the present disclosure.

1-9. (canceled)

10. A method for detecting radar signal-source number based on density clustering, comprising following steps:
generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to Gerschgorin Disk Estimator;
obtaining a noise background, and when the noise background is a Gaussian colored-noise background, compressing and standardizing the radius vector to obtain a target radius matrix;
clustering the target radius matrix using a target clustering algorithm to obtain a clustering result; and,
obtaining a target cluster based on the clustering result, and obtaining a number of radar signal sources based on the target cluster;
wherein the step of generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to Gerschgorin Disk Estimator, comprises following steps:
constructing an array steering vector corresponding to each signal source based on the target radar antenna-array information, generating a steering vector matrix based on the array steering vector, and generating the antenna-array received-data representation based on the steering vector matrix;
obtaining the target covariance matrix and a covariance matrix of a radar echo signal both based on the antenna-array received-data representation;
performing the unitary transformation on the target covariance matrix based on the covariance matrix of the radar echo signal to obtain the target transformation matrix; and,
according to Gerschgorin Disk Estimator, obtaining a Gerschgorin-disk radius of each Gerschgorin disk from the target transformation matrix, and generating the radius vector based on the Gerschgorin-disk radius;
wherein the step of performing the unitary transformation on the target covariance matrix based on the covariance matrix of the radar echo signal to obtain the target transformation matrix, comprises following steps:
dividing the target covariance matrix into blocks based on the covariance matrix of the radar echo signal to obtain a result after division, and obtaining a principal submatrix based on the result after division;
performing eigenvalue decomposition on the principal submatrix to obtain an eigenspace vector of the principal submatrix; and,
constructing a unitary-transformation matrix based on the eigenspace vector, and performing a unitary-transformation operation on the eigenspace vector based on the unitary transformation matrix to obtain the target transformation matrix;
wherein the step of obtaining a noise background, and when the noise background is a Gaussian colored-noise background, compressing and standardizing the radius vector to obtain a target radius matrix, comprises following steps:
obtaining the noise background, and determining a type of the noise background;
when the noise background is the Gaussian colored-noise background, compressing each Gerschgorin-disk radius of the radius vector based on the unitary-transformation matrix and a circle center of each Gerschgorin disk to obtain a plurality of compression radii;
standardizing each compression radius to obtain a target radius of each Gerschgorin disk; and,
generating the target radius matrix based on the target radius.

11. The method for detecting radar signal-source number based on density clustering according to claim 10, after the step of obtaining the noise background, and determining a type of the noise background, further comprising following steps:
when the noise background is a Gaussian white-noise background, performing a logarithmic transformation on the radius vector to obtain a logarithmic-transformation matrix;
clustering the logarithmic-transformation matrix using the target clustering algorithm to obtain a white-noise clustering result; and,
obtaining a white-noise target cluster based on the white-noise clustering result, and obtaining the corresponding number of radar signal sources based on the white-noise target cluster.

12. The method for detecting radar signal-source number based on density clustering according to claim 10, wherein the step of clustering the target radius matrix using a target clustering algorithm to obtain a clustering result, comprises following steps:
obtaining a preset distance threshold and a preset minimum neighborhood number, and using the target radius matrix, the distance threshold, and the minimum neighborhood number as an input for clustering;
during a process of the clustering, traversing each element of the target radius matrix, selecting core objects based on the minimum neighborhood number, adding the core objects to a core-object set and generating an ordered sequence, calculating a core distance and a reachable distance both of each core object, and based on the core distance and the reachable distance both of each core object of the ordered sequence, dividing all the core objects respectively into groups of a current clustering cluster, a new clustering cluster, and a noise point; and,
generating the clustering result based on the current clustering cluster, the new clustering cluster, and the noise point.

13. The method for detecting radar signal-source number based on density clustering according to claim 12, wherein the step of obtaining a target cluster based on the clustering result, and obtaining a number of radar signal sources based on the target cluster, comprises following steps:
calculating average values of the current clustering cluster and the new clustering cluster both of the clustering result, and selecting a cluster with a greater average value as the target cluster;
and,
counting a number of elements of the target cluster, and outputting the number of elements as the number of radar signal sources.

14. A system for detecting radar signal-source number based on density clustering, comprising:
a radius-vector generation module, configured to generate an antenna-array received-data representation based on target radar antenna-array information, obtain a target covariance matrix based on the antenna-array received-data representation, perform a unitary transformation on the target covariance matrix to obtain a target transformation matrix, and generate a radius vector corresponding to the target transformation matrix according to Gerschgorin Disk Estimator;
a target-radius-matrix generation module, configured to obtain a noise background, and when the noise background is a Gaussian colored-noise background, compress and standardize the radius vector to obtain a target radius matrix;
a clustering-result generation module, configured to cluster the target radius matrix using a target clustering algorithm to obtain a clustering result; and,
a result-output module, configured to obtain a target cluster based on the clustering result, and obtain a number of radar signal sources based on the target cluster;
wherein the step of generating an antenna-array received-data representation based on target radar antenna-array information, obtaining a target covariance matrix based on the antenna-array received-data representation, performing a unitary transformation on the target covariance matrix to obtain a target transformation matrix, and generating a radius vector corresponding to the target transformation matrix according to Gerschgorin Disk Estimator, comprises following steps:
constructing an array steering vector corresponding to each signal source based on the target radar antenna-array information, generating a steering vector matrix based on the array steering vector, and generating the antenna-array received-data representation based on the steering vector matrix;
obtaining the target covariance matrix and a covariance matrix of a radar echo signal both based on the antenna-array received-data representation;
performing the unitary transformation on the target covariance matrix based on the covariance matrix of the radar echo signal to obtain the target transformation matrix; and,
according to Gerschgorin Disk Estimator, obtaining a Gerschgorin-disk radius of each Gerschgorin disk from the target transformation matrix, and generating the radius vector based on the Gerschgorin-disk radius;
wherein the step of performing the unitary transformation on the target covariance matrix based on the covariance matrix of the radar echo signal to obtain the target transformation matrix, comprises following steps:
dividing the target covariance matrix into blocks based on the covariance matrix of the radar echo signal to obtain a result after division, and obtaining a principal submatrix based on the result after division;
performing eigenvalue decomposition on the principal submatrix to obtain an eigenspace vector of the principal submatrix; and,
constructing a unitary-transformation matrix based on the eigenspace vector, and performing a unitary-transformation operation on the eigenspace vector based on the unitary transformation matrix to obtain the target transformation matrix;
wherein the step of obtaining a noise background, and when the noise background is a Gaussian colored-noise background, compressing and standardizing the radius vector to obtain a target radius matrix, comprises following steps:
obtaining the noise background, and determining a type of the noise background;
when the noise background is the Gaussian colored-noise background, compressing each Gerschgorin-disk radius of the radius vector based on the unitary-transformation matrix and a circle center of each Gerschgorin disk to obtain a plurality of compression radii;
standardizing each compression radius to obtain a target radius of each Gerschgorin disk; and,
generating the target radius matrix based on the target radius.

15. A terminal, comprising: a memory, a processor, and a program for detecting radar signal-source number based on density clustering, wherein the program is stored on the memory and executable on the processor, and the program, when executed by the processor, implements the steps of the method for detecting radar signal-source number based on density clustering according to claim 10.
